(19) United States
(12) Patent Application Publication
(10) Pub. No.: US 2013/0126770 A1
(43) Pub. Date: May 23, 2013

(54) Anti-Cavitation and Noise Abatement Valve Trim

(71) Applicant: Target Rock Division of Curtiss-Wright Flow Contro, East Farmingdale, NY (US)

(72) Inventor: Hugh S. O'Brien, Huntington, NY (US)

(73) Assignee: Target Rock Division of Curtiss-Wright Flow Control Corporation, East Farmingdale, NY (US)

(21) Appl. No.: 13/677,523

(22) Filed: Nov. 15, 2012

Related U.S. Application Data
(60) Provisional application No. 61/563,436, filed on Nov. 23, 2011.

(51) Int. Cl. F16K 5/04

(52) U.S. Cl. CPC F16K 5/04
USPC 251/318

(57) ABSTRACT

A valve assembly that generally includes a valve body defining an inlet, an outlet and a fluid flow path between the inlet and the outlet, a valve seat disposed in the fluid flow path of the valve body between the inlet and the outlet, a disc movably supported in the valve body between an open position and a closed position, an actuating mechanism for selectively moving the disc between the open position and the closed position and a valve trim provided on the disc. The valve trim defines a plurality of apertures providing a semi-tortuous fluid flow path for modifying fluid flow through the valve trim when the disc is in the open position. When the disc is engaged with the valve seat in its closed position, the apertures are blocked to close the fluid flow path.

### CROSS-REFERENCE TO RELATED APPLICATIONS

This application claims the benefit of U.S. Provisional Application No. 61/563,436, filed on Nov. 23, 2011, the specification of which is incorporated by reference herein in its entirety for all purposes.

### TECHNICAL FIELD

The present disclosure relates to a trim intended to minimize cavitation and noise in valves with high pressure drops.

### BACKGROUND

In fluid systems, it is necessary to control the flow and pressure of fluids using valves. Modulating valves provide a variable controllable orifice to maximize operating range and efficiency of the process. A wide operating range includes a large flow range and a large pressure differential range. However, use of large modulating valves can produce undesirable results when operated with a high pressure differential, and particularly at the low end of their flow capability. Liquids that transition from a high to low pressure have potential for the undesirable effects of cavitation, noise and associated vibration. An abrupt pressure change yields several undesirable results.

Accordingly, it would be desirable to provide a valve that minimizes the problem of cavitation, noise and vibration, avoids reduced performance related to those problems and overcomes the various shortcomings of the prior art.

### SUMMARY OF THE INVENTION

In one embodiment, the valve assembly of the present invention generally includes a valve body defining an inlet, an outlet and a fluid flow path between the inlet and the outlet, a valve seat disposed in the fluid flow path of the valve body between the inlet and the outlet, a disc movably supported in the valve body between an open position and a closed position, an actuating mechanism for selectively moving the disc between the open position and the closed position and a valve trim provided on the disc. The valve trim defines a plurality of apertures providing a semi-tortuous fluid flow path for modifying fluid flow through the valve trim when the disc is in the open position. When the disc is engaged with the valve seat in its closed position, the apertures are blocked to close the fluid flow path.

In a preferred embodiment, the plurality of apertures include a staggered arrangement of restricting orifices arranged in parallel and in series with respect to the flow path. Also, there are a plurality of pressure drop chambers disposed between the restricting orifices in parallel and in series with respect to the flow path. The staggered arrangement of restricting orifices are preferably arranged in a plurality of parallel rows, wherein the rows define at least two separate and distinct fluid flow paths through the valve trim. At least two of the parallel rows of orifices may have different inter-orifice spacing or different orifice sizes and at least one of the rows of orifices may include orifices that are not aligned so as to better convolute the flow of fluid through the valve trim.

The disc preferably includes an outer wall engageable with the valve seat and an inner wall disposed coaxially within the outer wall such that a space is defined between the inner and outer walls. Both of the inner and outer walls have a plurality of apertures of the valve trim formed therethrough.

The valve trim further preferably includes an annular trim ring at least partially disposed coaxially in the space formed between the inner and outer walls of the disc. The trim ring includes a circumferential wall and has a plurality of apertures of the valve trim formed through the wall. In this case, the trim ring further preferably forms an outer ring of pressure drop chambers between the outer wall of the disc and the ring, and the trim ring also forms a middle ring of pressure drop chambers between the ring and the inner wall of the disc.

The valve trim further preferably includes a diffusing retainer attached to the disc for retaining the trim ring. This diffusing retainer has a plurality of apertures of the valve trim formed therethrough and includes an annular ring portion disposed coaxially within the inner wall of the disc and a flange portion extending radially outwardly from the ring portion. Preferably, both the ring portion and the flange portion of the diffusing retainer have the plurality of apertures of the valve trim formed therein. The ring portion of the diffusing retainer forms an inner ring of pressure drop chambers between the inner wall of the disc and the diffusing retainer.

The valve trim further preferably includes a sleeve disposed coaxially around the disc. The sleeve forms an annular sleeve chamber between the sleeve and the disc and has a plurality of apertures of the valve trim formed therethrough. The apertures formed through the sleeve may be triangular shaped, wherein the triangular shaped apertures have narrower portions disposed closer to the valve seat than oppositely disposed wider portions of the triangular shaped apertures.

The disc preferably defines an inner pressure control chamber and, in one embodiment, the disc includes a pressure supply control duct fluidly connecting the inner pressure control chamber with the annular sleeve chamber. Alternatively, the disc includes a pressure supply control duct fluidly connecting the valve body inlet with the inner pressure control chamber. In both embodiments, a control volume of fluid in the inner pressure control chamber operates the actuating mechanism.

The actuating mechanism may include an electromagnetic solenoid assembly. The actuating mechanism further preferably selectively moves and modulates the disc at any position within a full range of disc motion.

These and other aspects, objectives, features and advantages of the disclosed technologies will be apparent from the following detailed description of illustrative embodiments thereof, which is to be read in connection with the accompanying drawings.

### BRIEF DESCRIPTION OF THE DRAWINGS

The accompanying drawings, which are incorporated in and constitute a part of this disclosure, illustrate embodiments of the disclosure, and together with a general description of the disclosure given above, and the detailed description of the embodiments given below, serve to explain the principles of the present disclosure.

FIG. 1 is a cross-sectional side elevation view of a valve in an open position in accordance with aspects of the disclosed technologies.

FIG. 2 is a cross-sectional side elevation relief view of the disc trim portion of the valve shown in FIG. 1.

FIG. 3 is a perspective view of the sleeve in accordance with further aspects of the disclosed technologies.

FIG. 4 is a perspective exploded view of the disc, trim ring and diffusing retainer in accordance with aspects of the disclosed technologies.

FIG. 5 is an exploded side elevation view of the disc, trim ring and diffusing retainer, with a portion of the disc in section, in accordance with aspects of the disclosed technologies.

FIG. 6a is a cross-sectional side elevation further relief view of the valve trim relief indicated in FIG. 2, with fluid flow lines through the disc D_{Ao} and D_{Ai} orifices.

FIG. 6b is a cross-sectional side elevation further relief view of the valve trim relief indicated in FIG. 2, with fluid flow lines through the disc D_{Bo}, D_{Bi} and D_{D} orifices.

FIG. 6c is a cross-sectional side elevation further relief view of the valve trim relief indicated in FIG. 2, with fluid flow lines through the disc D_{C} orifices.

### DETAILED DESCRIPTION

Reference is now made to the drawings, in which like reference numerals identify identical or substantially similar parts throughout the several views.

The disclosed technologies minimize and/or resolve problems of cavitation erosion of valve components and piping, poor performance due to decreased flow, and excessive noise. Aspects of the disclosed technologies are particularly suited for a valve trim that improves control in boiler feed water valves, and more particularly with position modulating valves. The illustrative examples described herein relate to internally piloted valves. However, it should be understood that the disclosed technologies have application for various other valve designs.

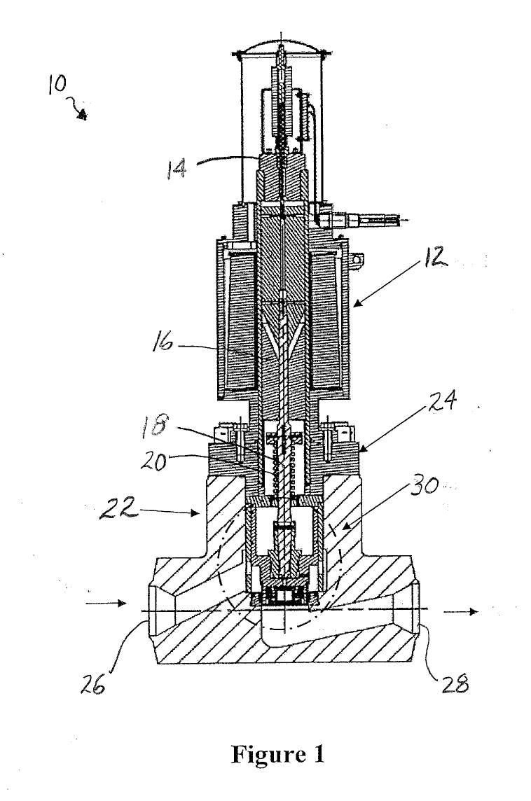

FIG. 1 shows a cross-sectional side elevation view of a fluid valve in accordance with aspects of the disclosed technologies. In particular, FIG. 1 shows an internally piloted solenoid valve 10 in an open position. Solenoid actuated valves generally provide for remote operation of open-close valve positioning. The upper portion of the valve assembly 10 includes the solenoid 12 and actuating mechanism 14. The solenoid 12 positions the valve by attracting a magnetic plunger 16 attached to a valve stem 18. These valves can be arranged such that power to the solenoid either opens or closes the valve. When power to the solenoid is removed, a spring 20 returns the valve stem 18 to the opposite position.

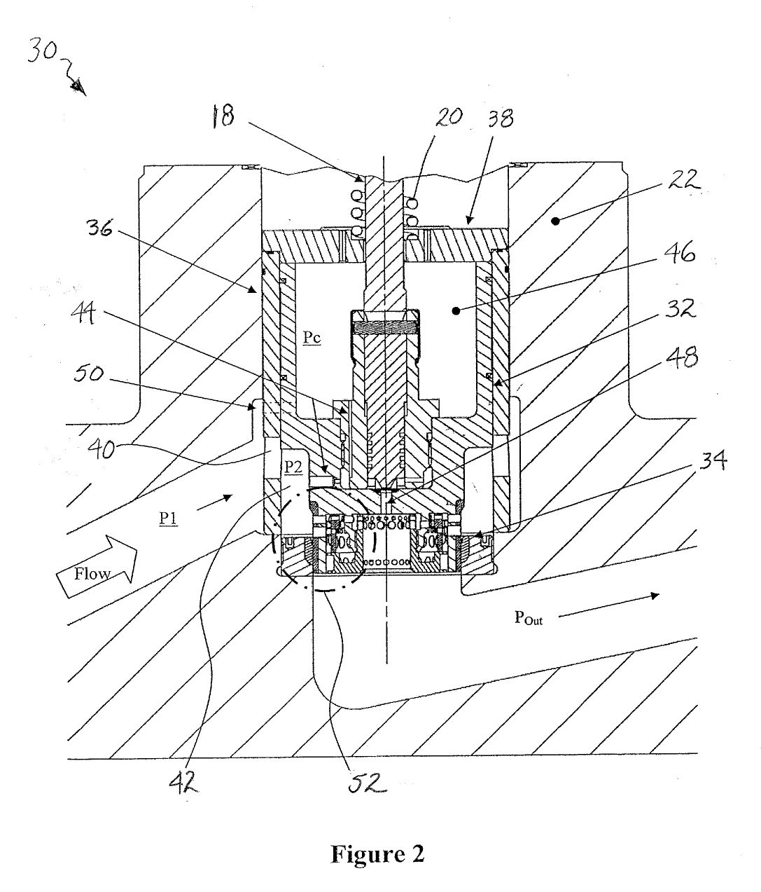

The lower portion of the valve 10 includes the valve body 22. A bonnet 24 is provided between the valve body 22 and the solenoid 12 for coupling and sealing the two elements of the valve 10. In this illustrative example, the bonnet 24 further provides support for the valve stem 18 and internal elements. The valve body 22 provides the fluid inlet 26 and outlet 28 ports. The fluid flows from the inlet 26 (upstream) to the outlet 28 (downstream). FIG. 1 shows a directional flow through the inlet 26 and outlet 28 ports from left to right, per the orientation of FIG. 1. However, such flow could be reversed. The circle depicted in phantom lines, refers to the valve trim 30, which is shown in the relief view of FIG. 2.

The internal elements of a valve are collectively referred to as a valve trim. Thus, the valve trim includes a disc 32, a seat 34, a sleeve 36 and the lower portion of the valve stem 18. The stem spring 20 and a spring retainer plate 38 could also be considered part of the valve trim 30. The disclosed valve trim design is also suitable for other valve types.

A valve's performance is often determined by the disk and seat interface and the relation of the disk position to the seat. In accordance with aspects of the disclosed technologies that disk can provide a convoluted or semi-tortuous fluid flow path that modifies and/or improves flow characteristics. Because of the valve trim, basic fluid motions and flow control are possible. The embodiment shown includes a linear motion trim design, where the lower portion of the disk drops vertically past the seat, so that the flow communication passages get blocked, thereby closing the valve.

The valve trim in accordance with aspects of the disclosed technologies is easily manufactured and assembled. Also, this valve trim may be adjusted by revising the machined flow holes in the components. Further, this valve trim enables proper sizing of a valve for flow capacity and achieves a desirable opening characteristic curve. An opening characteristic curve represents profile flow characteristics, such as quick, equal percentage, or linear opening.

As will be discussed in further detail below, the valve trim disclosed herein provides a staggered arrangement of restricting orifices in parallel and in series to control the flow. The staggered restricting orifices direct the flow in a convoluted path and control the pressure drop therein. Orifices can be simple round holes arranged in a pattern that achieves desired opening characteristic. Alternate geometric shapes can be machined by various manufacturing processes to achieve specific flow characteristics from the orifices. As the modulating valve disc 32 is opened, different arrangements of flow passages are exposed to allow a specific communication path from the valve inlet to the outlet.

In accordance with aspects of the disclosed technologies, after the flow is restricted, there is an expansion region for the fluid to recover to a state that is free of undue noise, cavitation and associated vibration. Arranging sufficient communication orifices in parallel modifies flow conditions. Thus, by modifying this aspect of the design various desirable flow conditions can be achieved. Also, by arranging sufficient orifices in series, the pressure drop within the fluid flow is more precisely throttled/controlled to minimize noise and cavitation. Further, altering the designed shape and number of communication orifices relative to the opening movement of the disc, will help achieve desired opening characteristics.

The disclosed valve trim controls flow and dissipates energy of high pressure fluid in a precisely controlled manner. Also, the disclosed trim does not require keying, pinning, or other means of aligning constricting rings. Unlike many existing trim designs with highly restrictive upstream cages, this valve enables use of high pressure supply gas to pilot-operate the valve actuator using a control pressure.

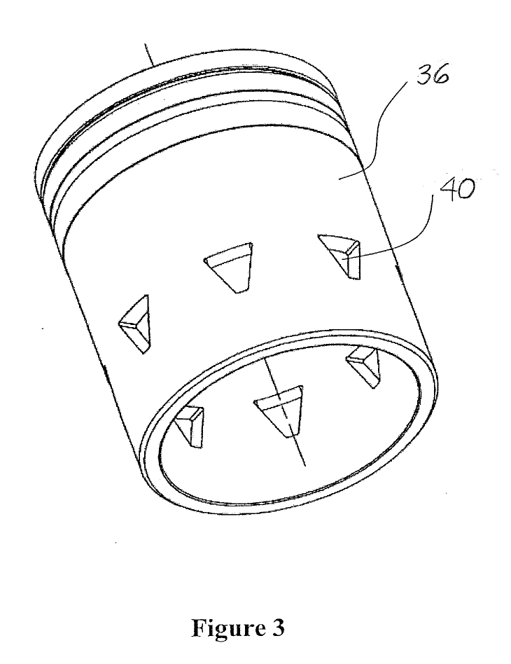

FIG. 2 shows an in-flow of fluid (indicated as “Flow”) coming in from the inlet (from the left) with an inlet pressure P1. The fluid then passes through a sleeve aperture 40 formed through the sleeve 36 (see, also FIG. 3). This first restriction of fluid flow through the sleeve aperture 40 causes a first pressure drop to a second pressure P2 in an annular sleeve chamber 42 just inside the sleeve. The annular sleeve chamber 42 is formed by a space defined between the inside of the sleeve 36 and the outside of the lowest portions of the disc 32, which is received within the sleeve. Thus, the fluid, when it reaches the sleeve chamber 42, would have a second lower pressure P2.

The sleeve 36 is generally fixed relative to the valve body 22, while the disc 32 can slide vertically down relative to the sleeve when actuated toward the closed position. The disc 32 is also provided with at least one pressure supply control duct 44, which communicates fluid pressure between the annular sleeve chamber 42 and an inner control chamber 46 formed within the disc. The fluid within the inner control chamber 46 has a control volume pressure Pc. The control volume pressure Pc is the control pressure of the internally piloted valve. The control volume pressure Pc is used to actuate the valve and also works in conjunction with a control vent 48 of the pilot valve. Also shown in dotted lines is an alternative pressure control passage 50, communicating the inlet pressure P1 directly to the control volume Pc through the sleeve 36 and the disc 32.

FIG. 3 shows the tubular sleeve 36 having sleeve apertures 40 formed through the circumferential wall of the sleeve. The sleeve apertures 40 are preferably non-round communication passages that are designed to achieve a specific opening characteristic. In a preferred embodiment, these passages have a triangular shape, which cause desired flow characteristics through the valve, particularly as the valve opens. As the valve opens, the lower narrower portion of the triangular aperture initially becomes open to the flow, with the upper wider portions subsequently also being exposed in a linear progression. Thus by altering the shape of those communication passages, one can adjust the flow opening characteristics.

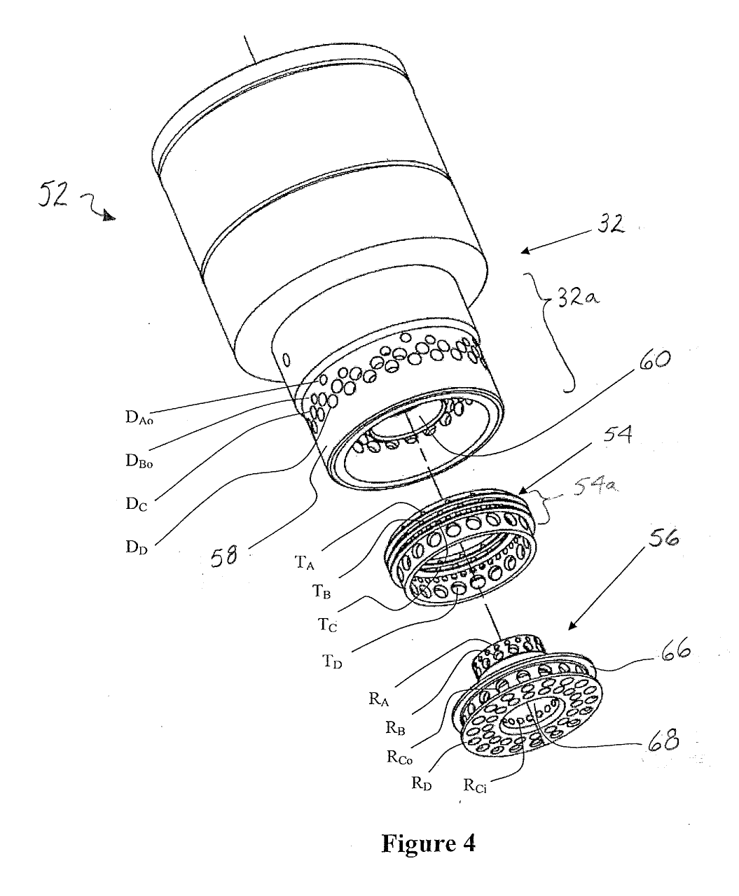

Once the fluid enters the sleeve chamber 42, it is next made to pass through a semi-tortuous flow path of staggered orifices in a disc trim 52. As used herein, the disc trim 52 refers to a combination of elements formed from the lowest portion 32a of the disc 32, a trim ring 54 and a diffusing retainer 56. The circle depicted in phantom lines in FIG. 2, refers to the disc trim 52, which is shown in the further relief views of FIGS. 4, 5 and 6a-6c. After passing through the disc trim 52, the fluid flows toward the outlet 28 at an outlet pressure P_{Out}.

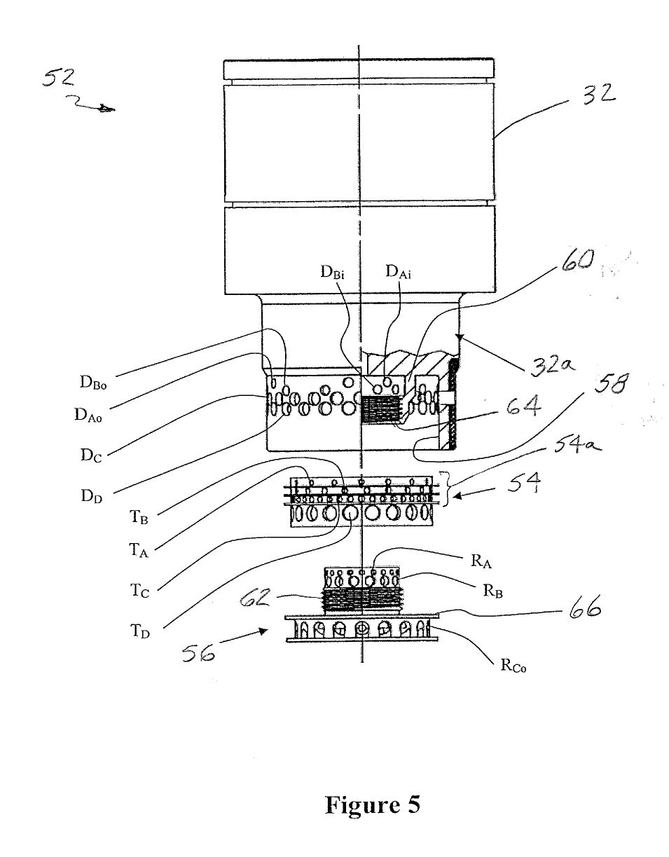

FIGS. 4 and 5 show exploded views of the disc trim 52. The trim ring 54 is shown retained by the diffusing retainer 56, which preferably threads into the disc 32. When assembled, the trim ring 54 gets inserted in the lower end 32a of the disc 32. In this way an upper portion 54a of the trim ring 54 is disposed between a disc outer retaining wall 58 and a disc inner retaining wall 60. Thereafter, or at the same time, the diffusing retainer 56 is also inserted into the same lower end 32a of the disc 32. Threading 62 is provided on an upper extension of the diffusing retainer 56, which mates with threading 64 on the inside of the disc inner retaining wall 60. Also, the diffusing retainer 56 includes a retaining flange 66 that sandwiches the trim ring 54 between that flange and the disc 32. The diffusing retainer 56 can be locked in place by a tack weld, or alternately locking threads or a setscrew can be used to ensure retention.

The convoluted or semi-tortuous fluid flow path is formed by sets of orifices through the disc outer retaining wall 58, trim ring 54, disc inner retaining wall 60 and diffusing retainer 56. The various apertures have different radial spacing in order to provide an almost random orientation between the series of holes. In this way, no keying of parts is necessary.

As shown in the drawings, orifices formed in the disc 32 have been given reference letter “D,” while orifices formed in the trim ring 54 have been given reference letter “T” and orifices formed in the diffusing retainer have been given reference letter “R.” From top to bottom of each of the disc 32, the trim ring 54 and diffusing retainer, the orifices shown in the drawings have been given sub-reference letters “A,” “B,” “C,” or “D,” with outer and inner elements further distinguished by sub-reference letters “o” or “i”, respectively.

Thus, orifices are provided around the lowest portion 32a of the disc 32 in rows, such that each row can have different inter-orifice spacing and/or different orifice size. The first row of orifices from the top of the disc outer retaining wall 58 is labeled as D_{Ao}, which are distinguished from the first row of orifices on the disc inner retaining wall 60, which are labeled as D_{Ai} (FIG. 5). Similarly, the second row of orifices from the top of the disc outer retaining wall 58 is labeled as D_{Bo}, which are distinguished from the second row of orifices on the disc inner retaining wall 60, which are labeled as D_{Bi}. Thereafter, the third and forth rows are labeled as D_{C} and D_{D} respectively.

Similarly, the trim ring 54 has rows of orifices at different levels labeled T_{A}, T_{B}, T_{C}, T_{D}. Further, the diffusing retainer 56 includes sets of orifices with the first two rows labeled as R_{A} and R_{B}. The diffusing retaining 56 is further provided with additional orifices just below the retaining flange 66 labeled as D_{Co}, which are distinguished from the opposed inner orifices facing a central chamber 68 of the diffusing retainer labeled as D_{Ci}. Also, the flange 66 of the diffusing retainer 56 includes sets of orifices facing downwardly labeled R_{D}.

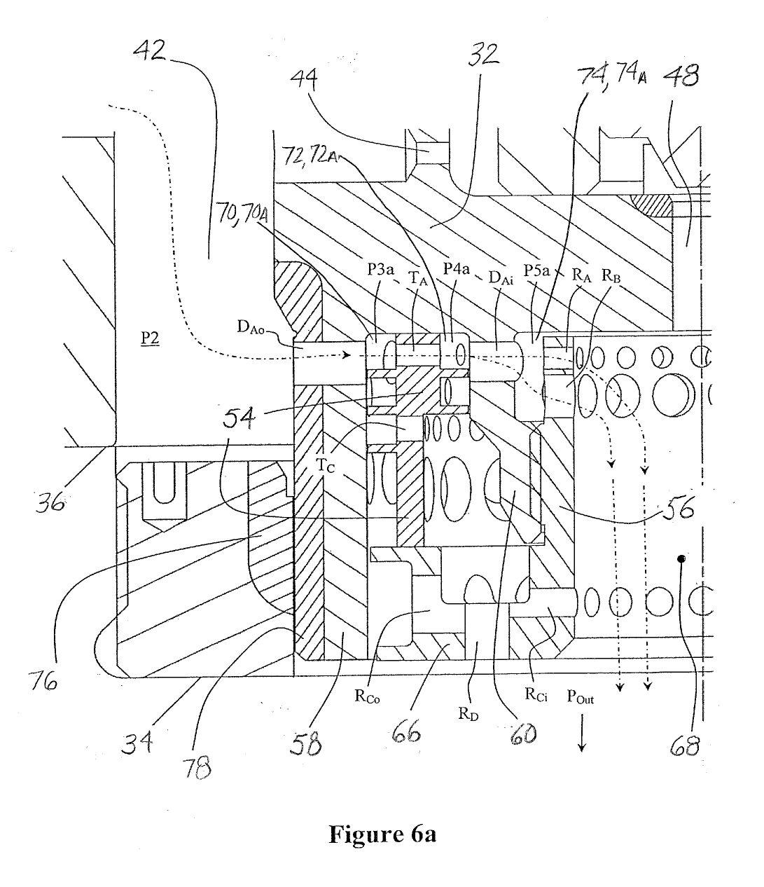

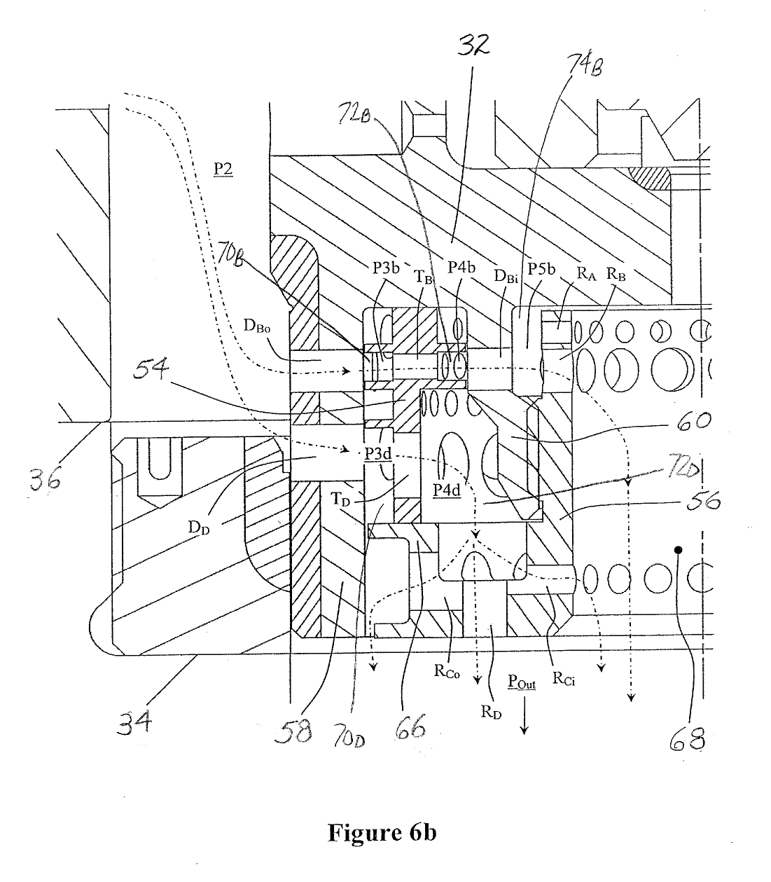

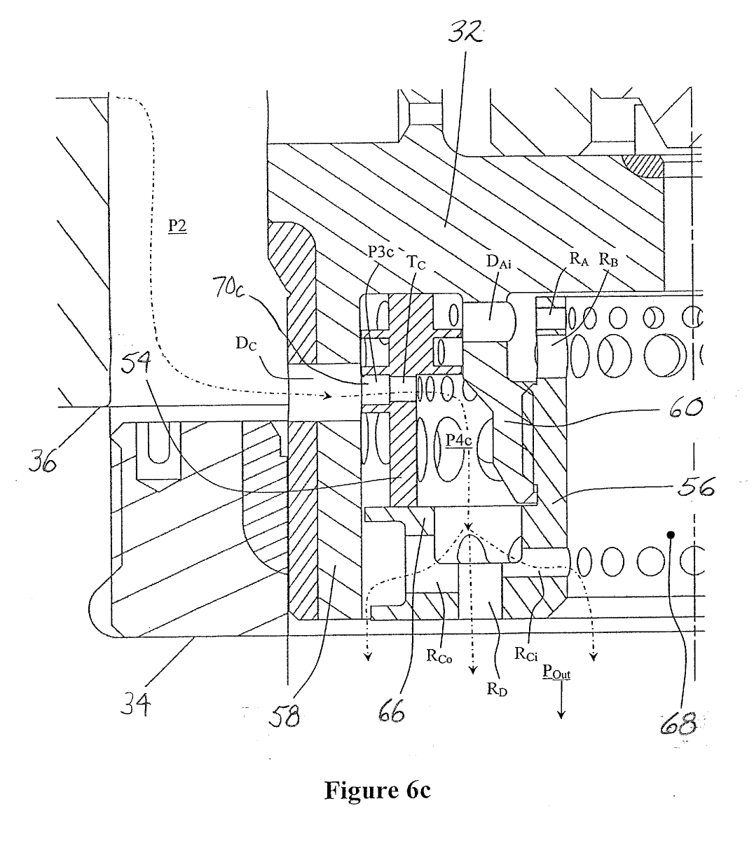

FIGS. 6a-6c show further detail views of the valve trim configuration with respect to the disc trim and the various orifices provided therein. The disc trim provides a series of successive pressure drops to the fluid. For example, as discussed above, a pressure drop from the inlet pressure P1 to sleeve chamber pressure P2, occurs just inside the sleeve 36 in the annular sleeve chamber 42. Thereafter, as the fluid progresses downstream, the pressure further drops to P3 just inside the disc outer retaining wall 58, then P4 just inside the trim ring 54, then P5 just inside the disc inner retaining wall 60, then Pₒᵤₜ as the fluid passes through the disc trim ring 56.

In this regard, there are flow paths that run in parallel and others that run in series, with various pressure changes across them. The structure of the disc outer retaining wall 58, the trim ring 54, the disc inner retaining wall 60 and the retaining diffuser 56 is such that respective pressure drop chambers are formed between each set of apertures. In particular, a plurality of outer ring pressure chambers 70 are formed between the disc outer retaining wall and the trim ring 54, a plurality of middle ring chambers 72 are formed between the trim ring 54 and the disc inner retaining wall 60 and a plurality of inner ring pressure chambers 74 are formed between the disc inner retaining wall 60 and the retaining diffuser 56. As will be discussed in further detail below, each ring of pressure chambers 70, 72, 74 are made up of rows of pressure chambers that are aligned between respective rows of apertures.

Thus, FIG. 6a shows a flow path example through a first row of apertures D_{Ao} in the disc outer retaining wall 58, which is aligned with a first row of trim ring apertures T_{A}, which is also aligned with a first row of apertures D_{Ai} formed in the disc inner retaining wall 60 leading still to two upper retaining diffuser apertures R_{A} and R_{B}, just before reaching the central chamber 68 and then toward the valve outlet. A first row of outer ring pressure drop chambers 70_{A} is formed between the first row of apertures D_{Ao} in the disc outer retaining wall 58 and the first row of apertures T_{A} in the trim ring 54.

Similarly, a first row of middle ring pressure drop chambers 72_{A} is formed between the first row of apertures T_{A} in the trim ring 54 and the first row of apertures D_{Ai} formed in the disc inner retaining wall 60. Finally, a first row of inner ring apertures 74_{A} is formed between the first row of apertures D_{Ai} formed in the disc inner retaining wall 60 and the two upper apertures R_{A} and R_{B} of the retaining diffuser 56. The fluid passing through this flow path experiences pressure drops including P3a in the first row of outer ring pressure drop chambers 70_{A}, P4a in the first row of middle ring pressure drop chambers 72_{A}, P5a in the first row of inner ring apertures 74_{A} and P_{Out} in the central chamber.

FIG. 6b shows a further example with a flow path through second and forth row of apertures D_{Bo} and D_{D} in the disc outer retaining wall 58. The upper aperture of those two D_{Bo} is aligned with a second row trim ring aperture T_{B}, which is also aligned with a disc inner retaining wall second row aperture D_{Bi}, leading again to two upper retaining diffuser apertures R_{A} and R_{B}, just before reaching the central chamber 68 and then toward the valve outlet. Here, a second row of outer ring pressure drop chambers 70_{B} is formed between the second row of apertures D_{Bo} in the disc outer retaining wall 58 and the second row of apertures T_{B} in the trim ring 54. Similarly, a second row of middle ring pressure drop chambers 72_{B} is formed between the second row of apertures T_{B} in the trim ring 54 and the second row of apertures D_{Bi} formed in the disc inner retaining wall 60. Finally, a second row of inner ring pressure drop chambers 74_{B} is formed between the second row of apertures D_{Bi} formed in the disc inner retaining wall 60 and the two upper apertures R_{A} and R_{B} of the retaining diffuser 56. The fluid passing through that second row flow path experiences pressure drops including P3b in the second row of outer ring pressure drop chambers 70_{B}, P4b in the second row of middle ring pressure drop chambers 72_{B}, P5b in the second row of inner ring pressure drop chambers and P_{Out} in the central chamber.

Meanwhile, the forth row aperture D_{D} is aligned with the forth row trim ring aperture T_{D}, which then leads to the various lower apertures R_{Co}, R_{Ci} and R_{D} in the diffusing retainer. In this case, only a fourth row of outer ring pressure drop chambers 70_{D} is formed between the fourth row of apertures D_{D} in the disc outer retaining wall 58 and the fourth row of apertures T_{D} in the trim ring 54 and a fourth row of middle ring pressure drop chambers 72_{D} is formed between the fourth row of apertures T_{B} in the trim ring 54 and the flange apertures R_{D} formed in the flange 66 of the diffusing retainer 56. The fluid passing through that forth row flow path experiences pressure drops including P3d in the fourth row of outer ring pressure drop chambers 70_{D}, P4d in the fourth row of middle ring pressure drop chambers 72_{D} and eventually P_{Out}.

FIG. 6c shows a further example with a flow path through a third row aperture D_{C} in the disc outer retaining wall 58, which is aligned with a third row trim ring aperture T_{C}, which then leads to the various lower apertures R_{Co}, R_{Ci} and R_{D} in the diffusing retainer 56. A third row of outer ring pressure drop chambers 70_{C} is formed between the third row of apertures D_{C} in the disc outer retaining wall 58 and the third row of apertures T_{C} in the trim ring 54 and the fourth row of middle ring pressure drop chambers 72_{D} is here again provided between the third row of apertures T_{C} in the trim ring 54 and the various lower apertures R_{Co}, R_{Ci} and R_{D} formed in the diffusing retainer 56 The fluid passing through that third row flow path experiences pressure drops including P3c, P4c and eventually P_{Out}.

In accordance with an aspect of the disclosed technologies, the area across which the fluid flows as it moves downstream will increase as it moves through the series of flow passages. In the embodiment shown, this is achieved by providing increased numbers and/or sizes of apertures from the external apertures in the disc 32, through the trim ring 54 and the diffusing retainer 56. While a different number or configuration of apertures could be provided in any of those elements, it is advantageous to require the fluid to pass through a series of staggered apertures in order to provide a convoluted flow path. Such a convoluted flow path assists in providing a pressure drop as the fluid passing through the valve trim. Also, this promotes proper flow without cavitation or undue noise as the fluid velocity increases. Velocity increase is a physical phenomenon of fluid flow that is throttled to a lower pressure. The valve trim components are additionally designed such that structural divisions between regions of separate flow and pressures are sized to withstand the mechanical stresses of the pressure and flow.

Unlike many existing trims that have highly restrictive orifices on the downstream side of the disc, this trim enables the control pressure vent to communicate directly to the outlet pressure, to ensure proper operation of the pilot actuator.

Although illustrative embodiments of the present disclosure have been described herein with reference to the accompanying drawings, it is to be understood that the invention is not limited to those precise embodiments and that various other changes and modifications may be effected herein by one skilled in the art without departing from the scope or spirit of the invention. For example, assembly of the valve according to the present disclosure can be further facilitated by providing a seat hard face insert 76 on the seat 34 and a disc hard face insert 78 on the disc outer retaining wall 58.

Also, it will be appreciated that various of the above-disclosed and other features and functions, or alternatives thereof, may be desirably combined with various systems or applications. It will further be appreciated that various presently unforeseen or unanticipated alternatives, modifications, variations, or improvements therein may be subsequently made by those skilled in the art which are also intended to be encompassed by the disclosed embodiments and the following claims.

What is claimed is:

1. A valve assembly comprising:
a valve body defining an inlet, an outlet and a fluid flow path between said inlet and said outlet;
a valve seat disposed in said fluid flow path of said valve body between said inlet and said outlet;
a disc movably supported in said valve body between an open position and a closed position, said disc being engaged with said valve seat in said closed position to close said fluid flow path;
an actuating mechanism for selectively moving said disc between said open position and said closed position; and
a valve trim provided on said disc, said valve trim defining a plurality of apertures providing a semi-tortuous fluid flow path for modifying fluid flow through said valve trim when said disc is in said open position, said apertures being blocked when said disc is in said closed position.

2. A valve assembly as defined in claim 1, wherein said plurality of apertures comprises a staggered arrangement of restricting orifices arranged in parallel and in series with respect to said flow path.

3. A valve assembly as defined in claim 2, wherein said valve trim further comprises a plurality of pressure drop chambers disposed between said restricting orifices in parallel and in series with respect to said flow path.

4. A valve assembly as defined in claim 2, wherein said staggered arrangement of restricting orifices are arranged in a plurality of parallel rows, said rows defining at least two separate and distinct fluid flow paths through said valve trim.

5. A valve assembly as defined in claim 4, wherein at least two of said parallel rows of orifices have different inter-orifice spacing or different orifice sizes.

6. A valve assembly as defined in claim 4, wherein at least one of said rows of orifices comprises orifices that are not aligned.

7. A valve assembly as defined in claim 1, wherein said disc comprises an outer wall engageable with said valve seat and an inner wall disposed coaxially within said outer wall, said inner and outer walls defining a space therebetween and having a plurality of said apertures of said valve trim formed therethrough.

8. A valve assembly as defined in claim 7, wherein said valve trim further comprises an annular trim ring at least partially disposed coaxially in said space between said inner and outer walls of said disc, said trim ring comprising a circumferential wall and having a plurality of said apertures of said valve trim formed through said wall.

9. A valve assembly as defined in claim 8, wherein said trim ring forms an outer ring of pressure drop chambers between said outer wall of said disc and said ring, and wherein said trim ring forms a middle ring of pressure drop chambers between said ring and said inner wall of said disc.

10. A valve assembly as defined in claim 9, wherein said valve trim further comprises a diffusing retainer attached to said disc for retaining said trim ring, said diffusing retainer having a plurality of said apertures of said valve trim formed therethrough.

11. A valve assembly as defined in claim 10, wherein said diffusing retainer comprises an annular ring portion disposed coaxially within said inner wall of said disc and a flange portion extending radially outwardly from said ring portion.

12. A valve assembly as defined in claim 11, wherein both said ring portion and said flange portion of said diffusing retainer have said plurality of said apertures of said valve trim formed therein.

13. A valve assembly as defined in claim 12, wherein said ring portion of said diffusing retainer forms an inner ring of pressure drop chambers between said inner wall of said disc and said diffusing retainer.

14. A valve assembly as defined in claim 1, wherein said valve trim further comprises a sleeve disposed coaxially around said disc, said sleeve forming an annular sleeve chamber between said sleeve and said disc and having a plurality of said apertures of said valve trim formed therethrough.

15. A valve assembly as defined in claim 14, wherein said plurality of apertures formed through said sleeve are triangular shaped, said triangular shaped apertures having narrower portions disposed closer to said valve seat than oppositely disposed wider portions of said triangular shaped apertures.

16. A valve assembly as defined in claim 14, wherein said disc defines an inner pressure control chamber and further includes a pressure supply control duct fluidly connecting said inner pressure control chamber with said annular sleeve chamber,
wherein a control volume of fluid in said inner pressure control chamber operates said actuating mechanism.

17. A valve assembly as defined in claim 14, wherein said disc defines an inner pressure control chamber, and wherein said sleeve includes a pressure supply control duct fluidly connecting said inner pressure control chamber with said valve body inlet, wherein a control volume of fluid in said inner pressure control chamber operates said actuating mechanism.

18. A valve assembly as defined in claim 1, wherein said actuating mechanism comprises an electromagnetic solenoid assembly.

19. A valve assembly as defined in claim 1, wherein said actuating mechanism selectively moves and modulates said disc at any position within a full range of disc motion.

20. A valve trim for a fluid control valve handling high pressure fluid, the fluid control valve including a valve body having a fluid inlet port, a fluid outlet port and a valve seat disposed between the inlet and outlet ports, the fluid control valve adapted to receive a valve disc in the valve seat, the valve disc moveable within the valve body along an axis between closed and open valve positions, the valve disc comprising:
a disc body for selectively providing fluid communication between the inlet and outlet ports, the disc body including an outer retaining wall having a plurality of outer retaining wall apertures, the outer retaining wall forming a first annular extension at a bottom of the disc body, the outer retaining wall forming a first inner disc area inside the outer retaining wall, the disc body including an inner retaining wall having a plurality of inner retaining wall apertures, the inner retaining wall forming a second annular extension at the bottom of the disc body, the inner retaining wall disposed inside the outer retaining wall, the inner retaining wall forming a second inner disc area inside the inner retaining wall, the outer retaining wall apertures extending from an area outside the outer retaining wall to the first inner disc area, the inner retaining wall apertures extending from an area outside the inner retaining wall to the second inner disc area;
a sleeve having a plurality of sleeve apertures, at least one of the sleeve apertures adapted to provide fluid communication between the inlet port and at least one inner retaining wall aperture, the sleeve disposed outside the outer retaining wall;
a trim ring having a plurality of trim ring apertures, at least one of the trim ring apertures adapted to provide fluid communication between the first inner disc area and the area outside the inner retaining wall, the trim ring disposed between the outer retaining wall and the inner retaining wall; and
a diffusing retainer having a plurality of diffuser apertures, at least one of the diffuser apertures adapted to provide fluid communication between the second inner disc area and a central chamber of the diffusing retainer, the central chamber being in fluid communication with the outlet port, the diffusing retainer including a retaining flange for maintaining the trim ring between the diffusing retainer and the disc body.
